(19) United States
(12) Patent Application Publication
(10) Pub. No.: US 2017/0358816 A1
(43) Pub. Date: Dec. 14, 2017

(54) ALL-SOLID-STATE BATTERY AND METHOD FOR PRODUCING THE SAME

(71) Applicant: TOYOTA JIDOSHA KABUSHIKI KAISHA, Toyota-shi (JP)

(72) Inventor: Koichi SUGIURA, Susono-shi (JP)

(21) Appl. No.: 15/617,461

(22) Filed: Jun. 8, 2017

(30) Foreign Application Priority Data
Jun. 13, 2016 (JP) 2016-117000

(51) Int. Cl. H01M 10/0525; H01M 10/0565; H01M 4/66

(52) U.S. Cl. CPC H01M 10/0525; H01M 4/667; H01M 10/0565; H01M 4/661

(57) ABSTRACT

An all-solid-state battery which can maintain a desired power output in normal use and reduce an excessive increase in battery temperature when an abnormality is caused by an external shock, etc. The all-solid-state battery may comprise a cathode, an anode and a solid electrolyte layer disposed between the cathode and the anode, wherein the cathode and/or the anode comprises: an aluminum substrate comprising an aluminum oxide layer having a thickness of from 0.01 to 0.1 μm on a surface thereof, and an electrode active material layer formed on the aluminum oxide layer.

### TECHNICAL FIELD

The disclosure relates to an all-solid-state battery and a method for producing the same.

### BACKGROUND

An all-solid-state battery has attracted attention as a very safe battery, since solid electrolyte has better heat resistance than liquid electrolyte.

For safe transportation of an all-solid-state battery, there is an attempt to reduce Joule heat generation that is due to an internal short circuit caused by a shock to the battery, etc.

A non-aqueous secondary battery is disclosed in Patent Literature 1, which has such a positive temperature coefficient (PTC) function, that the resistance of the battery increases when the temperature of at least one of the cathode, anode and non-electrolyte of the battery exceeds a predetermined temperature. In particular, it is mentioned that the PTC function is exercised by mixing a crystalline thermoplastic polymer with an electrode material or with an electroconductive material contained in the non-aqueous electrolyte of the battery.

In Patent Literature 2, it is disclosed that in order to increase battery durability by reducing the elution of an electroconductive material, which is a component of a current collector, into an electrolyte, the current collector is heat-treated to form an oxide layer on the surface.

In Patent Literature 3, it is disclosed that in order to prevent an active material from peeling off, the surface of a current collector is subjected to a boehmite or chromate treatment to form an oxide layer having a thickness of from 0.5 to 5 μm.

Patent Literature 1: Japanese Patent Application Laid-Open (JP-A) No. 1999-329503

Patent Literature 2: JP-A No. 2000-156328

Patent Literature 3: JP-A No. 2000-048822

### SUMMARY

A resin-based resistor having the PTC function as disclosed in Patent Literature 1, has a problem in that the thickness required of the resistor is large and results in an increase in battery volume and thus a decrease in energy density.

The disclosed embodiments were achieved in light of the above circumstance. An object of the disclosed embodiments is to provide an all-solid-state battery which can, without a large decrease in energy density, maintain a desired power output in normal use and reduce an excessive increase in battery temperature when an abnormality is caused by an external shock, etc.

In a first embodiment, there is provided an all-solid-state battery comprising a cathode, an anode and a solid electrolyte layer disposed between the cathode and the anode. The cathode and/or the anode comprises: an aluminum substrate comprising an aluminum oxide layer having a thickness of from 0.01 to 0.1 μm on a surface thereof, and an electrode active material layer formed on the aluminum oxide layer.

A resistance of the all-solid-state battery may be 2980 mΩ/cm² or more at a load of 15 MPa and 150 mΩ/cm² or less at a load of 400 MPa.

The aluminum substrate may comprise the aluminum oxide layer on a whole surface thereof.

In another embodiment, there is provided a method for producing the above-mentioned all-solid-state battery, the method comprising a step of forming the aluminum oxide layer on the aluminum substrate surface by subjecting the aluminum substrate to an alumite or boehmite treatment for 10 to 50 seconds.

The all-solid-state battery can be provided according to the disclosed embodiments, which can maintain a desired power output in normal use and reduce an excessive increase in battery temperature when an abnormality is caused by an external shock, etc.

### BRIEF DESCRIPTION OF THE DRAWINGS

FIG. 1 is a schematic sectional view of an example of the all-solid-state battery according to an embodiment;

FIG. 2 is a schematic view of an example of surface resistance measurement of an aluminum oxide layer;

FIG. 3 is a bar graph showing the results of measuring the surface resistances of aluminum oxide layers at a load of 15 MPa;

FIG. 4 is a bar graph showing the results of measuring the surface resistances of aluminum oxide layers at a load of 400 MPa;

FIG. 5 is a bar graph showing the results of calculating the power output retention rates of batteries;

FIG. 6 is a schematic sectional view of an example of the all-solid-state battery at the time of nail penetration;

FIG. 7 is a bar graph showing the results of measuring generated heat temperatures;

FIG. 8 is a view showing the result of observing the generated heat temperature of Example 1;

FIG. 9 is a view showing the result of observing the generated heat temperature of Example 6; and

FIG. 10 is a view showing the result of observing the generated heat temperature of Comparative Example 1.

### DETAILED DESCRIPTION

It has been confirmed by a nail penetration test, which is a battery safety test, that Joule heat generation is caused by a short circuit that is caused when a cathode current collector is brought into contact with an anode active material layer or anode current collector by an internal short circuit. Therefore, the Joule heat generation can be reduced by increasing the resistance of the surface of any one of the electrode current collectors.

However, an increase in the surface resistance of the electrode current collector leads to a decrease in power output.

Therefore, for example, a method for exercising the PTC function by, as disclosed in Patent Literature 1, forming a carbon coat layer composed of an electroconductive material and a resin, has been studied.

However, to exercise the function, cutting the electroconductive path of the electroconductive material by volume expansion of the resin, is needed. According to the probability theory, a certain level of thickness (3 to 10 μm) is required of the resin. Therefore, there is a problem in that an increase in battery volume occurs and causes a decrease in battery energy density.

The all-solid-state battery according to the disclosed embodiments comprises the aluminum oxide layer on the surface of the aluminum substrate. Compared to the thickness of the resistor disclosed in Patent Literature 1 (the resin-based resistor having the PTC function), the thickness of the aluminum oxide layer is as thin as 0.01 to 0.1 μm; moreover, the resistance of the battery surface is made small by a press pressure applied in the production of the battery. Therefore, a decrease in battery energy density can be reduced, and a desired power output can be maintained when the battery is in normal use.

When an abnormality (such as peeling off of an interface) is caused to the all-solid-state battery of the disclosed embodiments by an external shock load, etc., due to load reduction, the resistance of the aluminum oxide layer formed on the surface of the aluminum substrate rapidly increases to reduce current inside the battery; therefore, an excessive increase in battery temperature can be reduced.

That is, according to the disclosed embodiments, the battery can maintain a desired power output in normal use, without a large decrease in energy density, and the aluminum oxide layer can exercise the battery function suspending effect when an abnormality is caused by an external shock, etc.

In addition, the production process of the aluminum oxide layer can be simplified when the aluminum oxide layer is formed by oxidizing the aluminum substrate.

### 1. All-Solid-State Battery

The all-solid-state battery of the disclosed embodiments is an all-solid-state battery comprising a cathode, an anode and a solid electrolyte layer disposed between the cathode and the anode, wherein the cathode and/or the anode comprises: an aluminum substrate comprising an aluminum oxide layer having a thickness of from 0.01 to 0.1 μm on a surface thereof, and an electrode active material layer formed on the aluminum oxide layer.

The resistance of the all-solid-state battery of the disclosed embodiments may be 2980 mΩ/cm² or more at a load of 15 MPa and 150 mΩ/cm² or less at a load of 400 MPa.

The pressure condition of 15 MPa is an example of a pressure in the case of load reduction when an abnormality is caused by an external shock, etc. It is also a condition on the assumption that an abnormality occurs in the battery. Since the resistance of the battery is 2980 mΩ/cm² or more at a load of 15 MPa, the current inside the battery is reduced in the event of an abnormality such as an external shock; therefore, an excessive increase in battery temperature can be reduced.

The pressure condition of 400 MPa is an example of a press pressure in the production of the all-solid-state battery. It is also a condition on the assumption that the battery is in normal use. Since the resistance of the battery is 150 mΩ/cm² or less at a load of 400 MPa, a desired output can be obtained when the battery is in normal use.

It is considered that once a good interface is formed between the electrode and the solid electrolyte layer in the production of the all-solid-state battery, the interface is not peeled off as long as an external shock (abnormal shock) is not applied by a nail, etc.

To form a good interface, the battery may be pressed at at least 200 MPa or more.

The resistance of the aluminum oxide layer surface is high at the time of pressing at low pressure (e.g., 15 MPa) and is low at the time of pressing at high pressure (e.g., 400 MPa). This is considered to be because, at the time of pressing at high pressure, the electrode active material penetrates the thin aluminum oxide layer formed on the surface, or the aluminum oxide layer expands, thereby decreasing the contact resistance between the electrode active material layer and the aluminum oxide layer surface, along with an increase in load.

The all-solid-state battery of the disclosed embodiments is applicable to a lithium battery, a sodium battery, a magnesium battery, a calcium battery, etc. Of them, the all-solid-state battery of the disclosed embodiments may be a lithium battery. Also, the all-solid-state battery of the disclosed embodiments may be a primary battery or a secondary battery. Of them, the all-solid-state battery of the disclosed embodiments may be a secondary battery, because the battery can be charged and discharged repeatedly and is usable as a car battery, for example.

The all-solid-state battery of the disclosed embodiments may be a single cell or a cell assembly composed of a plurality of single cells. As the cell assembly, examples include, but are not limited to, a cell stack composed of a stack of a plurality of flat place cells.

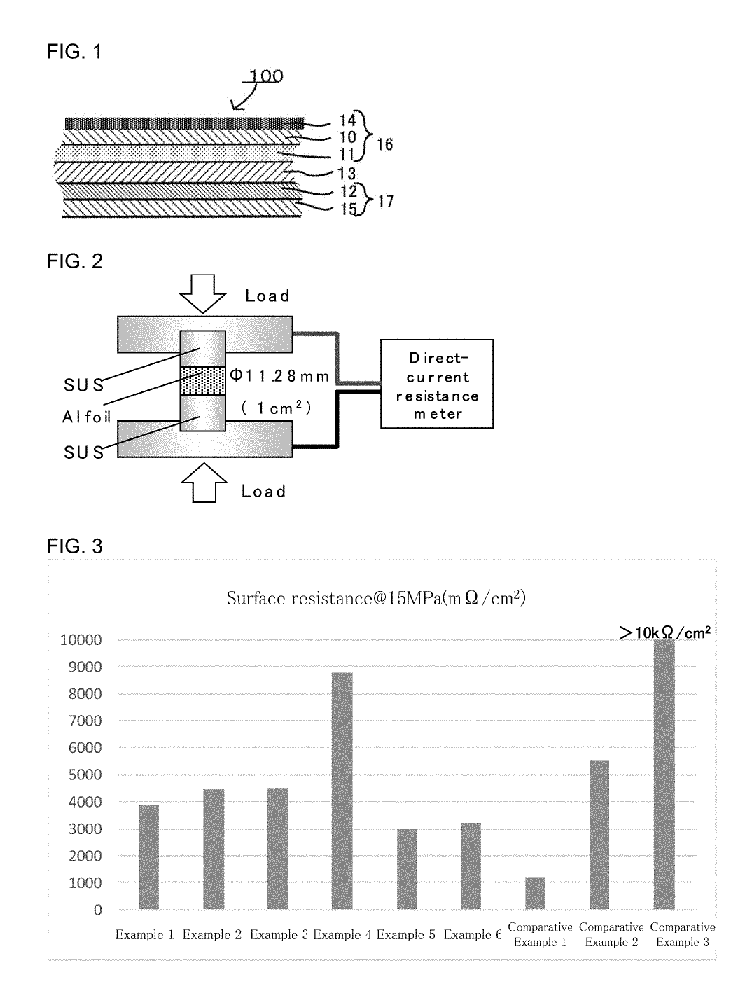

FIG. 1 is a schematic sectional view of an example of the all-solid-state battery of the disclosed embodiments. The battery of the disclosed embodiments is not limited to this example.

An all-solid-state battery 100 comprises an electrode 16, a counter electrode 17 and a solid electrolyte layer 13. The electrode 16 comprises: an aluminum substrate 14 comprising an aluminum oxide layer 10 formed on the surface thereof, and an electrode active material layer 11 formed on the aluminum oxide layer 10. The counter electrode 17 comprises a counter electrode layer 12 and a current collector 15 configured to collect current from the counter electrode layer 12. The solid electrolyte layer 13 is disposed between the electrode active material layer 11 and the counter electrode layer 12.

For example, when a cathode active material layer is stacked on the solid electrolyte layer 13 as the electrode active material layer 11, an anode active material layer is stacked on the solid electrolyte layer 13 as the counter electrode layer 12. On the other hand, when an anode active material layer is stacked on the solid electrolyte layer 13 as the electrode active material layer 11, a cathode active material layer is stacked on the solid electrolyte layer 13 as the counter electrode layer 12.

The electrode is not particularly limited, as long as it comprises: the aluminum substrate comprising the aluminum oxide layer formed on the surface thereof, and the electrode active material layer formed on the aluminum oxide layer.

The counter electrode is not particularly limited, as long as it comprises the counter electrode layer and the current collector configured to collect current from the counter electrode layer. The current collector may be an aluminum substrate comprising an aluminum oxide layer formed on the surface thereof. In this case, the counter electrode layer may be formed on the aluminum oxide layer.

The electrode active material layer is not particularly limited, as long as it contains at least an electrode active material.

The potential of the electrode active material used determines whether the electrode is a cathode or an anode and whether the electrode active material layer is a cathode active material layer or an anode active material layer. When the electrode is a cathode, the counter electrode is an anode. When the electrode active material layer is a cathode active material layer, the counter electrode layer is an anode active material layer.

The electrode active material is not particularly limited, as long as it can occlude and/or release ions such as lithium ions.

The form of the electrode active material is not particularly limited. The electrode active material may be in a particulate form.

As the electrode active material, examples include, but are not limited to, layered active materials such as LiCoO₂, LiNiO₂, LiCo_{1/3}Ni_{1/3}Mn_{1/3}O₂, LiVO₂ and LiCrO₂; different element-substituted Li—Mn spinels such as LiMn₂O₄ and those represented by Li₁₊ₓMn_{2-x-y}M_{y}O₄ (where M is at least one selected from the group consisting of Al, Mg, Co, Fe, Ni and Zn); spinel-type active materials such asLi₂NiMn₃O₈; lithium titanates such as Li₄Ti₅O₁₂; olivine-type active materials such as LiMPO₄ (where M is at least one of Fe, Mn, Co and Ni); NASICON-type active materials such as Li₃V₂P₃O₁₂; transition metal oxides such as trivalent vanadium (V₂O₅) and molybdenum oxide (MoO₃); transition metal sulfides such as titanium sulfide (TiS₂); carbonaceous materials such as mesocarbon microbeads (MCMB), graphite, highly oriented pyrolytic graphite (HOPG), hard carbon and soft carbon; lithium cobalt nitrides such as LiCoN; lithium silicon oxides such as LiₓSi_{y}O_{z}; lithium metal (Li); lithium alloys such as LiM (where M is Sn, Si, Al, Ge, Sb, P, etc.); metals such as In, Al, Si and Sn; and lithium storage intermetallic compounds such as MgₓM (where M is at least one of Sn, Ge and Sb) and N_{y}Sb (where N is at least one of In, Cu and Mn) and derivatives thereof. Of these electrode active materials, LiCoO₂, LiNi_{1/3}Mn_{1/3}Co_{1/3}O₂, LiFePO₄, LiMn₂O₄, LiMnPO₄ or the like may be used as the cathode active material. As the anode active material, carbonaceous materials such as graphite, highly oriented pyrolytic graphite (HOPG), hard carbon and soft carbon may be used.

There is no clear distinction between the cathode active material and the anode active material. A battery with a desired voltage can be formed by comparing the charge-discharge potentials of two kinds of compounds and using one showing a noble potential as the cathode and one showing a less potential as the anode.

In the disclosed embodiments, the electrode active material particles may be single-crystal particles of an electrode active material, or they may be such polycrystalline electrode active material particles, that electrode active material single crystals are connected on a crystal plane level.

In the disclosed embodiments, the average particle diameter of the electrode active material particles is not particularly limited. The average particle diameter of the electrode active material particles may be from 0.1 to 30 μm. When the electrode active material particles are such polycrystalline electrode active material particles, that electrode active material single crystals are connected, the average particle diameter of the electrode active material particles means the average particle diameter of the polycrystalline electrode active material particles.

In this specification, unless otherwise noted, the term “average particle diameter” means a median diameter (50% volume average particle diameter; hereinafter it may be referred to as “D50”) derived from a particle size distribution measured by means of a laser scattering/diffraction particle size distribution analyzer.

When the electrode active material layer is the cathode active material layer, the cathode active material layer is not particularly limited, as long as it contains at least a cathode active material. As needed, the cathode active material layer may contain at least one of an electroconductive material and a binder. Even when the counter electrode layer is the cathode active material layer, the cathode active material layer is the same as the case where the electrode active material layer is the cathode active material layer.

The thickness of the cathode active material layer is not particularly limited. For example, the lower limit may be 2 nm or more, or it may be 100 nm or more. The upper limit may be 1000 μm or less, or it may be 500 μm or less, for example.

The electroconductive material is not particularly limited, as long as it can increase the electroconductivity of the cathode active material layer. As the electroconductive material, examples include, but are not limited to, an electroconductive carbonaceous material.

The electroconductive carbonaceous material is not particularly limited. From the viewpoint of the area or space of reaction sites, the electroconductive carbonaceous material may be a carbonaceous material with a high specific surface area. More specifically, the electroconductive carbonaceous material may have a specific surface area of 10 m²/g or more, 100 m²/g or more, or 600 m²/g or more.

As the electroconductive carbonaceous material with a high specific surface area, examples include, but are not limited to, carbon black (e.g., acetylene black, Ketjen Black), activated carbon and carbon fibers (e.g., carbon nanotubes (CNT), carbon nanofibers, vapor-grown carbon fibers).

The specific surface area of the electroconductive material can be measured by the BET method, for example.

The content ratio of the electroconductive material in the cathode active material layer varies depending on the type of the electroconductive material. When the total mass of the cathode active material layer is determined as 100% by mass, generally, it may be from 1 to 30% by mass.

As the binder, examples include, but are not limited to, acrylic binders; fluorine resins such as polyvinylidene fluoride (PVdF), polytetrafluoroethylene (PTFE), a tetrafluoroethylene-hexafluoropropylene-vinylidene fluoride copolymer, a hexafluoropropylene-vinylidene fluoride copolymer, and a tetrafluoroethylene-perfluorovinyl ether copolymer; and rubber resins such as butadiene rubber (BR) and styrene-butadiene rubber (SBR). The rubber resins are not particularly limited, and a hydrogenated butadiene rubber and such a hydrogenated butadiene rubber that functional groups are introduced in terminals thereof, may be used. These binders may be used alone or in combination of two or more kinds.

The content ratio of the binder in the cathode active material layer may be one that can fix the cathode active material, etc., and it may be as small as possible. When the total mass of the cathode active material layer is determined as 100% by mass, generally, the content ratio of the binder may be from 0 to 10% by mass.

The method for producing the cathode active material layer is not particularly limited. When the cathode active material used as a raw material is in a particulate form, the cathode active material layer can be produced by mixing the cathode active material particles, the electroconductive material and the binder at a desired ratio, for example.

The method for mixing them is not particularly limited and may be wet mixing or dry mixing.

As the wet mixing, examples include, but are not limited to, the following method: the cathode active material particles, the electroconductive material, the binder and a dispersion medium are mixed to produce a slurry, and the slurry is applied and dried, thereby producing the cathode active material layer. As the dispersion medium, examples include, but are not limited to, butyl butyrate, butyl acetate, dibutyl ether and heptane. As the method for applying the slurry, examples include, but are not limited to, a screen printing method, a gravure printing method, a die coating method, a doctor blade method, an inkjet method, a metal mask printing method, an electrostatic coating method, a dip coating method, a spray coating method and a roller coating method. More specifically, the cathode active material layer can be formed by applying the slurry to the below-described current collector or a carrier film, drying the applied slurry and, as needed, roll-pressing and/or cutting the resulting product.

As the dry mixing, examples include, but are not limited to, a method of mixing the cathode active material particles, the electroconductive material and the binder with a mortar or the like.

When the electrode active material layer is the anode active material layer, the anode active material layer is not particularly limited, as long as it contains at least an anode active material. As needed, the anode active material layer may contain at least one of an electroconductive material and a binder. Even when the counter electrode layer is the anode active material layer, the anode active material layer is the same as the case where the electrode active material layer is the anode active material layer.

The content of the anode active material in the anode active material layer may be 10% by mass or more, for example, or it may be in a range of from 20% by mass to 90% by mass.

The electroconductive material and binder used for the anode active material layer are the same as the case of the above-described cathode active material layer. The thickness of the anode active material layer is not particularly limited, and it may be in a range of from 0.1 μm to 1000 μm, for example.

The method for producing the anode active material layer is not particularly limited. For example, the anode active material layer may be produced by the following method: a mixture of the anode active material and, as needed, other components such as the binder, is dispersed in a dispersion medium to prepare a slurry, and the slurry is applied onto a current collector, dried and roll-pressed, thereby producing the anode active material layer.

The dispersion medium and the method for applying the slurry are the same as the above-described method for producing the cathode active material layer.

The aluminum substrate comprises the aluminum oxide layer having a thickness of from 0.01 to 0.1 μm on the surface thereof and functions as a current collector for collecting current from the electrode active material layer. When the electrode active material layer formed on the aluminum oxide layer is the cathode active material layer, the aluminum substrate functions as the cathode current collector for collecting current from the cathode active material layer. When the electrode active material layer is the anode active material layer, the aluminum substrate functions as the anode current collector for collecting current from the anode active material layer.

The aluminum substrate may be used as at least any one of the cathode current collector and the anode current collector. It may be used as the cathode current collector. Both the cathode current collector and the anode current collector may be the aluminum substrates.

As the aluminum substrate, examples include, but are not limited to, an Al foil.

The thickness of the aluminum substrate is not particularly limited and may be from 6 to 20 μm. From the viewpoint of work efficiency and decreasing the resistance of the battery, it may be from 10 to 20 μm. From the viewpoint of decreasing the volume of the battery, it may be from 10 to 15 μm.

The current collector may be composed of a material other than the aluminum substrate. The material other than the aluminum substrate is not particularly limited, as long as it has electroconductivity. As the material, examples include, but are not limited to, metal materials such as stainless-steel, nickel, iron, titanium, copper, gold, silver and palladium; carbonaceous materials such as carbon fibers and carbon paper; and high electron conductive ceramic materials such as titanium nitride.

As the form of the current collector composed of the material other than the aluminum substrate, examples include, but are not limited to, a foil form, a plate form and a mesh form. The form of such a current collector may be a foil form.

The thickness of the current collector composed of the material other than the aluminum substrate, is not particularly limited. For example, it may be from 10 to 1000 μm, or it may be from 20 to 400 μm.

The current collector (including the aluminum substrate) may have a terminal that serves as a connection to the outside.

The thickness of the aluminum oxide layer formed on the surface of the aluminum substrate may be from 0.01 to 0.1 μm.

To exercise the battery function suspending effect when an abnormality is caused by an external shock, etc., the aluminum oxide layer may be formed on the surface of at least a part of the aluminum substrate where the aluminum substrate is in contact with the electrode active material layer. When an electrical conductor (such as a nail) penetrates a battery to cause an internal short circuit, an increase in temperature can be efficiently reduced if the aluminum oxide layer, which serves as an insulator, is disposed around the electrical conductor such as a nail. Therefore, the aluminum substrate may comprise the aluminum oxide layer on a whole surface thereof.

As the method for forming the aluminum oxide layer, examples include, but are not limited to, a boehmite treatment and an alumite treatment.

The solid electrolyte layer contains at least a solid electrolyte. As needed, it contains a binder, etc.

The solid electrolyte contained in the solid electrolyte layer is not particularly limited. When the all-solid-state battery of the disclosed embodiments is an all-solid-state lithium secondary battery, examples include, but are not limited to, Li₂O—B₂O₃—P₂O₅-based, Li₂O—SiO₂-based, Li₂O—B₂O₃-based, and Li₂O—B₂O₃—ZnO-based oxide solid electrolytes and combinations thereof; Li₂S—SiS₂-based, Li₂S—P₂S₃-based, Li₂S—P₂S₅-based, Li₂S—GeS₂-based, Li₂S—B₂S₃-based, Li₃PO₄—P₂S₅-based, and Li₄SiO₄—Li₂S—SiS₂-based sulfide solid electrolytes and combinations thereof; crystalline sulfides, oxides and oxynitrides such as LiI, LiI—Al₂O₃, Li₃N, Li₃N—LiI—LiOH, Li_{1.3}Al_{0.3}Ti_{0.7} (PO₄)₃, Li_{1+x+y}MₓTi₂₋ₓSi_{y}P_{3-y}O₁₂ (where M is at least one of Al and Ga; 0≦x≦0.4; and 0≦x≦0.6), [(M_{1/2}Li_{1/2})_{1-z}N_{z}]TiO₃ (where M is at least one of La, Pr, Nd and Sm; N is at least one of Sr and Ba; and 0≦x≦0.5), Li₅La₃Ta₂O₁₂, Li₇La₃Zr₂O₁₂, Li₆BaLa₂Ta₂O₁₂, Li₃PO_{4-3/2x}Nₓ (where x<1) and Li_{3.6}Si_{0.6}P_{0.4}O₄; and lithium compounds such as LiF, LiCl, LiBr, LiI, Li₃PO₄, Li₄SiO₄ and Li₄GeS₄, and combinations thereof. Of them, the solid electrolyte may be a Li₂S—P₂S₅-based sulfide solid electrolyte, or it may be a sulfide solid electrolyte represented by the following general formula: xLiI.(100−x)(0.75Li₂S.0.25P₂S₅) (where x is 0<x<30).

The content of the solid electrolyte in the solid electrolyte layer may be 60% by mass or more, 70% by mass or more, or 80% by mass or more, for example.

The binder used for the solid electrolyte layer is the same as the case of the above-described cathode active material layer. The thickness of the solid electrolyte layer may be in a range of from 0.1 μm to 1000 μm, or it may be in a range of from 0.1 μm to 300 μm, for example.

The method for producing the solid electrolyte layer is not particularly limited. A stack of the solid electrolyte layer and the cathode and/or anode active material layer can be produced by preparing a pressed powder of the solid electrolyte, placing the pressed powder on the cathode and/or anode active material layer, and then pressing them.

The all-solid-state battery of the disclosed embodiments generally comprises an outer casing for housing the electrode, the solid electrolyte layer, the counter electrode, etc. As the form of the outer casing, examples include, but are not limited to, a coin form, a flat plate form, a cylindrical form and a laminate form.

The material for the outer casing is not particularly limited, as long as it is stable to solid electrolytes. As the material, examples include, but are not limited to, metal materials such as Al and SUS, and resins such as polypropylene, polyethylene and acrylic resins.

When the outer casing is composed of a metal material, only the surface of the outer casing may be composed of a metal material, or the whole outer casing may be composed of a metal material.

### 2. All-Solid-State Battery Production Method

The all-solid-state battery production method of the disclosed embodiments is a method for producing the above-mentioned all-solid-state battery, the method comprising a step of forming the aluminum oxide layer on the aluminum substrate surface by subjecting the aluminum substrate to an alumite or boehmite treatment for 10 to 50 seconds.

The aluminum oxide layer forming step is the a step of forming the aluminum oxide layer on the aluminum substrate surface by subjecting the aluminum substrate to an alumite or boehmite treatment for 10 to 50 seconds.

The boehmite treatment time and the alumite treatment time may be from 10 to 50 seconds.

As the boehmite treatment, a conventional method may be used. Examples include, but are not limited to, a method of forming an oxide film on the aluminum substrate surface in water vapor such as high-temperature ultrapure water. A small amount of alkaline solution (e.g., ammonia water) may be added to the ultrapure water.

As the alumite treatment, a conventional method may be used. Examples include, but are not limited to, a method of anodizing the aluminum substrate by connecting the aluminum substrate to the electrode.

### EXAMPLES

### Example 1

### [Formation of Aluminum Oxide Layer]

An Al foil (product name: 1N30H; manufactured by: UACJ; thickness: 15 μm) was used as an aluminum substrate. The Al foil was subjected to a boehmite treatment for 10 seconds to form an aluminum oxide layer on the surface. The thickness of the aluminum oxide layer was 0.01 μm.

### [Production of Solid Electrolyte Layer]

As starting materials, lithium sulfide (Li₂S; manufactured by: Nippon Chemical Industrial Co., Ltd.; purity: 99.9%), diphosphorus pentasulfide (P₂S₅; manufactured by: Aldrich; purity: 99%) and lithium iodide (LiI; manufactured by: Kojundo Chemical Laboratory Co., Ltd.; purity: 99%) were used. Next, inside a glove box under an Ar atmosphere (dew point: −70° C.), the Li₂S and the P₂S₅ were weighed so that they were at a mole ratio of 75Li₂S.25P₂S₅. Then, the LiI was weighed so that it was 10 mol %. Then, 2 g of a mixture of them was put in a planetary ball mill container (45 ml, composed of ZrO₂). In addition, dehydrated heptane (moisture content: 30 ppm or less; 4 g; manufactured by: Kanto Chemical Co., Inc.) and then ZrO₂ balls (diameter: 5 mm; 53 g) were put in the container. Then, the container was absolutely and hermetically closed (under an Ar atmosphere). This container was installed in a planetary ball mill (product name: P7; manufactured by: FRITSCH) and subjected to 40 cycles of a mechanical milling at a plate rotational frequency of 500 rpm for one hour with a pause of 15 minutes. A sample thus obtained was dried on a hot plate at 120° C. for two hours to remove the heptane from the sample, thereby obtaining a coarse-grained raw material (sulfide solid electrolyte). The composition of the thus-obtained sulfide solid electrolyte is represented by the general formula xLiI.(100−x)(0.75Li₂S.0.25P₂S₅) where x is 10.

The coarse-grained raw material thus obtained, dehydrated heptane (manufactured by Kanto Chemical Co., Inc.) and dibutyl ether were mixed so that the total mass was 10 g and the mass of the coarse-grained raw material was 10% of the total mass, thereby obtaining a mixture.

The mixture thus obtained, dibutyl ether and ZrO₂ balls (diameter: 1 mm; total: 40 g) were put in the planetary ball mill container (45 ml, composed of ZrO₂). Then, the container was absolutely and hermetically closed (under an Ar atmosphere). This container was installed in the planetary ball mill (product name: P7; manufactured by: FRITSCH) and subjected to wet mechanical milling at a plate rotational frequency of 150 rpm for 20 hours to pulverize the coarse-grained raw material, thereby obtaining sulfide solid electrolyte fine particles.

Then, 1 g of the thus-obtained sulfide solid electrolyte fine particles were placed on an aluminum petri dish and kept on a hot plate at 180° C. for two hours to crystallize the sulfide solid electrolyte fine particles, thereby obtaining sulfide solid electrolyte crystalline particles.

Then, 1 g of the sulfide solid electrolyte crystalline particles, that is, 1 g of 10LiI.90(0.75Li₂S.0.25P₂S₅) particles, were mixed with 0.01 g of a binder (PVdF). A mixture thus obtained was pressed to form a pressed powder of a solid electrolyte layer.

### [Production of Cathode]

First, LiNi_{1/3}Co_{1/3}Mn_{1/3}O₂ particles (manufactured by Nichia Corporation) were coated with LiNbO₃ to prepare oxide-covered active material particles (average particle diameter D50: 5 μm).

Then, 52 g of the oxide-covered active material particles as a cathode active material, 17 g of 10LiI-15LiBr-75(0.75Li₂S-0.25P₂S₅) particles as a sulfide solid electrolyte, 1 g of vapor-grown carbon fibers (VGCFs; manufactured by Showa Denko K. K.) as an electroconductive material, and 15 g of dehydrated heptane (manufactured by Kanto Chemical Co., Inc.) were sufficiently mixed to obtain a cathode mixture slurry.

The thus-obtained cathode mixture slurry was applied onto the Al foil subjected to the boehmite treatment. The applied cathode mixture slurry was dried, thereby obtaining a cathode.

### [Production of Anode]

First, 36 g of graphite (manufactured by Mitsubishi Chemical Corporation) as an anode active material and 25 g of 10LiI-15LiBr-75(0.75Li₂S-0.25P₂S₅) particles as a sulfide solid electrolyte, were mixed to obtain an anode mixture slurry.

The thus-obtained anode mixture slurry was applied onto a Cu foil and dried, thereby obtaining an anode.

[Production of all-Solid-State Battery]

Next, the cathode was placed on one side of the pressed powder of the solid electrolyte layer, and the anode was placed on the other side. They were subjected to flat pressing at a press pressure of 6 ton/cm² (≈588 MPa) for a pressing time of one minute, thereby producing a single cell. A total of 20 single cells were produced in this manner and stacked. The cell stack was pressed in the stacking direction at a press pressure of 6 ton/cm² (≈588 MPa). Then, a current collection tab was attached to the terminals of the cell stack by ultrasonic welding. The cell stack was vacuum-encapsulated with an aluminum laminate, thereby obtaining an all-solid-state battery with a battery capacity of 2 Ah.

### Example 2

An all-solid-state battery was produced in the same manner as Example 1, except that an Al foil was used as an aluminum substrate and subjected to a boehmite treatment for 20 seconds to form an aluminum oxide layer on the surface of the Al foil. The thickness of the aluminum oxide layer was 0.03 μm.

### Example 3

An all-solid-state battery was produced in the same manner as Example 1, except that an Al foil was used as an aluminum substrate and subjected to a boehmite treatment for 30 seconds to form an aluminum oxide layer on the surface of the Al foil. The thickness of the aluminum oxide layer was 0.05 μm.

### Example 4

An all-solid-state battery was produced in the same manner as Example 1, except that an Al foil was used as an aluminum substrate and subjected to a boehmite treatment for 40 seconds to form an aluminum oxide layer on the surface of the Al foil. The thickness of the aluminum oxide layer was 0.07 μm.

### Example 5

An all-solid-state battery was produced in the same manner as Example 1, except that an Al foil was used as an aluminum substrate and subjected to an alumite treatment for 10 seconds to form an aluminum oxide layer on the surface of the Al foil. The thickness of the aluminum oxide layer was 0.04 μm.

### Example 6

An all-solid-state battery was produced in the same manner as Example 1, except that an Al foil was used as an aluminum substrate and subjected to an alumite treatment for 50 seconds to form an aluminum oxide layer on the surface of the Al foil. The thickness of the aluminum oxide layer was 0.1 μm.

### Comparative Example 1

An all-solid-state battery was produced in the same manner as Example 1, except that although an Al foil was used as an aluminum substrate, the Al foil was not subjected to a boehmite treatment and an aluminum oxide layer was not formed on the surface of the Al foil.

### Comparative Example 2

An all-solid-state battery was produced in the same manner as Example 1, except that an Al foil was used as an aluminum substrate and subjected to a boehmite treatment for 80 seconds to form an aluminum oxide layer on the surface of the Al foil. The thickness of the aluminum oxide layer was 0.13 μm.

### Comparative Example 3

An all-solid-state battery was produced in the same manner as Example 1, except that an Al foil was used as the aluminum substrate and subjected to an alumite treatment for 100 seconds to form an aluminum oxide layer on the surface of the Al foil. The thickness of the aluminum oxide layer was 0.2 μm.

TABLE 1

| | | | | | | | Generated |
|---|---|---|---|---|---|---|---|
| | | | | | | Power | heat |
| | | | Thickness | Surface | Surface | output | temperature |
| | Oxidation | | (μm) of | resistance | resistance | retention | (K) in nail |
| | treatment | Treatment | aluminum | (mΩ/cm²) @ | (mΩ/cm²) @ | rate | penetration |
| | method | time (s) | oxide layer | 15 MPa | 400 MPa | (%) | test |
| Example 1 | Boehmite | 10 | 0.01 | 3900 | 28 | 93.2 | 65 |
| Example 2 | Boehmite | 20 | 0.03 | 4430 | 30 | 95.3 | 55 |
| Example 3 | Boehmite | 30 | 0.05 | 4490 | 40 | 95.0 | 34 |
| Example 4 | Boehmite | 40 | 0.07 | 8790 | 86 | 96.4 | 31 |
| Example 5 | Alumite | 10 | 0.04 | 2980 | 110 | 94.0 | 34 |
| Example 6 | Alumite | 50 | 0.1 | 3230 | 128 | 93.2 | 22 |
| Comparative | — | — | — | 1210 | 13 | 100 | 101 |
| Example 1 | | | | | | | |
| Comparative | Boehmite | 80 | 0.13 | 5550 | 246 | 63 | 19.5 |
| Example 2 | | | | | | | |
| Comparative | Alumite | 100 | 0.2 | >10 kΩ/cm² | >10 kΩ/cm² | Non- | Non- |
| Example 3 | | | | | | evaluable | evaluable |

### [Surface Resistance Measurement of Aluminum Oxide Layer]

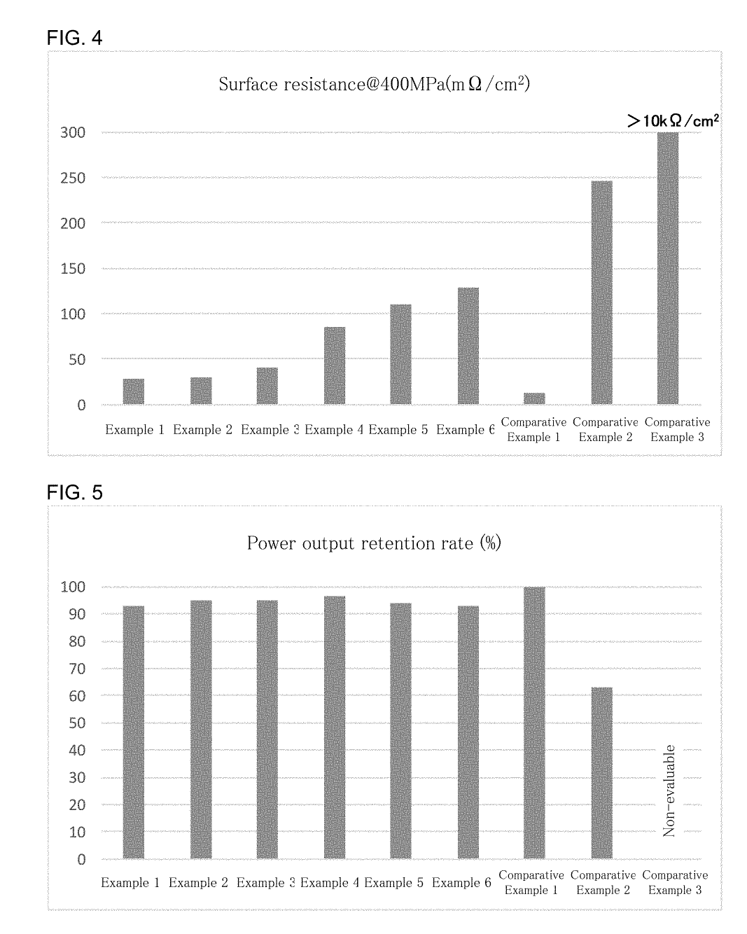

FIG. 2 is a schematic view of an example of surface resistance measurement of an aluminum oxide layer. As shown in FIG. 2, the Al foil used in Comparative Example 1, which was not subjected to a surface treatment, was cut to have a diameter of 11.28 cm (area: 1 cm²). The Al foil was measured for surface resistance values when both sides of the Al foil were pressed by a SUS jig at a load of 15 MPa and a load of 400 MPa. Each of the measured surface resistance values is a value from which the resistance value of a wiring and that of the jig were subtracted. In the same manner, the surface resistance values of the surface-treated Al foils of Examples 1 to 6 and Comparative Examples 2 and 3, were measured. The results are shown in Table 1, FIG. 3 (the surface resistances at a load of 15 MPa) and FIG. 4 (the surface resistances at a load of 400 MPa).

The surface resistances at a load of 15 MPa are as follows: 3900 mΩ/cm² in Example 1, 4430 mΩ/cm² in Example 2, 4490 mΩ/cm² in Example 3, 8790 mΩ/cm² in Example 4, 2980 mΩ/cm² in Example 5, 3230 mΩ/cm² in Example 6, 1210 mΩ/cm² in Comparative Example 1, 5550 mΩ/cm² in Comparative Example 2, and larger than 10 kΩ/cm² in Comparative Example 3.

The surface resistances at a load of 400 MPa are as follows: 28 mΩ/cm² in Example 1, 30 mΩ/cm² in Example 2, 40 mΩ/cm² in Example 3, 86 mΩ/cm² in Example 4, 110 mΩ/cm² in Example 5, 128 mΩ/cm² in Example 6, 13 mΩ/cm² in Comparative Example 1, 246 mΩ/cm² in Comparative Example 2, and larger than 10 kΩ/cm² in Comparative Example 3.

### [Evaluation for Battery Capacity]

Constant-current charge and constant-current discharge (CC charge-CC discharge) were carried out by the all-solid-state batteries obtained in Examples 1 to 6 and Comparative Examples 1 to 3. The battery capacities of the all-solid-state batteries were measured in the following condition:
CC charge-discharge rate: 1/3 C (0.67 A)
Cutoff current: 0.02 A
Charge cutoff voltage: 4.55 V
Discharge cutoff voltage: 3.0 V

The battery capacities are as follows: 1.78 Ah in Example 1, 1.77 Ah in Example 2, 1.80 Ah in Example 3, 1.80 Ah in Example 4, 1.66 Ah in Example 5, 1.75 Ah in Example 6, 1.79 Ah in Comparative Example 1, 1.70 Ah in Comparative Example 2, and 1.69 Ah in Comparative Example 3. From these results, it was confirmed that there is no large influence on battery capacity even if the all-solid-state battery comprises the aluminum oxide layer.

### [Evaluation for Battery Power Output]

Constant power discharge (40 to 50 Wh) was carried out by the all-solid-state batteries obtained in Examples 1 to 6 and Comparative Examples 1 to 3. The battery voltage was set to 3.6 V, and the maximum power the battery can discharge for 5 seconds, was measured as a battery power output. The discharge cutoff voltage was 3.0 V. The battery power outputs are as follows: 51.3 mW/cm² in Example 1, 52.4 mW/cm² in Example 2, 52.3 mW/cm² in Example 3, 53.0 mW/cm² in Example 4, 51.3 mW/cm² in Example 5, 51.2 mW/cm² in Example 6, 55 mW/cm² in Comparative Example 1, 34.7 mW/cm² in Comparative Example 2, and non-evaluable in Comparative Example 3 (since the battery could not be charged). It is clear that while Examples 1 to 6 can provide similar power outputs to Comparative Example 1 (the battery not comprising the aluminum oxide layer), the power output of Comparative Example 2 is significantly lower than Comparative Example 1. Therefore, it is clear that as long as the thickness of the aluminum oxide layer is 0.01 μm or more and 0.1 μm or less, a desired power output can be obtained when the battery is in normal use.

### [Evaluation for Power Output Retention Rate]

For each of the all-solid-state batteries obtained in Examples 1 to 6 and Comparative Examples 1 to 3, the power output retention rate was calculated from a value obtained by determining Comparative Example 1 as a basis and dividing the above-measured battery power output value by the basis. The results are shown in Table 1 and FIG. 5. The power output retention rates of Examples 1 to 6 and Comparative Examples 2 and 3 in Table 1, are corresponding values when the power output retention rate of Comparative Example 1 is determined as 100.

The power output retention rates of the batteries when the power output retention rate of Comparative Example 1 is determined as 1000, are as follows: 93.2% in Example 1, 95.3% in Example 2, 95.0% in Example 3, 96.4% in Example 4, 94.0% in Example 5, 93.2% in Example 6, 63.0% in Comparative Example 2, and non-evaluable in Comparative Example 3 (since the battery could not be charged).

It is clear that while Examples 1 to 6 can obtain similar power output retention rates to Comparative Example 1 (the battery not comprising the aluminum oxide layer), the power output retention rate of Comparative Example 2 is significantly lower than Comparative Example 1. Therefore, it is clear that as long as the thickness of the aluminum oxide layer is 0.01 μm or more and 0.1 μm or less, a desired power output can be obtained even if charge and discharge are repeated when the battery is in normal use.

From the results of the surface resistance measurement of the aluminum oxide layer, the evaluation of the battery power output, and the evaluation of the battery power output retention rate, it is clear that in the case of Examples 1 to 6, that is, in the case where the surface resistance is 128 mΩ/cm² or less at a load of 400 MPa, a desired power output can be obtained when the battery is in normal use.

### [Nail Penetration Test]

The all-solid-state batteries obtained in Examples 1 to 6 and Comparative Examples 1 to 3 were each pressed at 15 MPa, charged to 4.18 V and kept at a temperature of 25° C. in advance. In this condition, each battery was installed in a nail penetration tester.

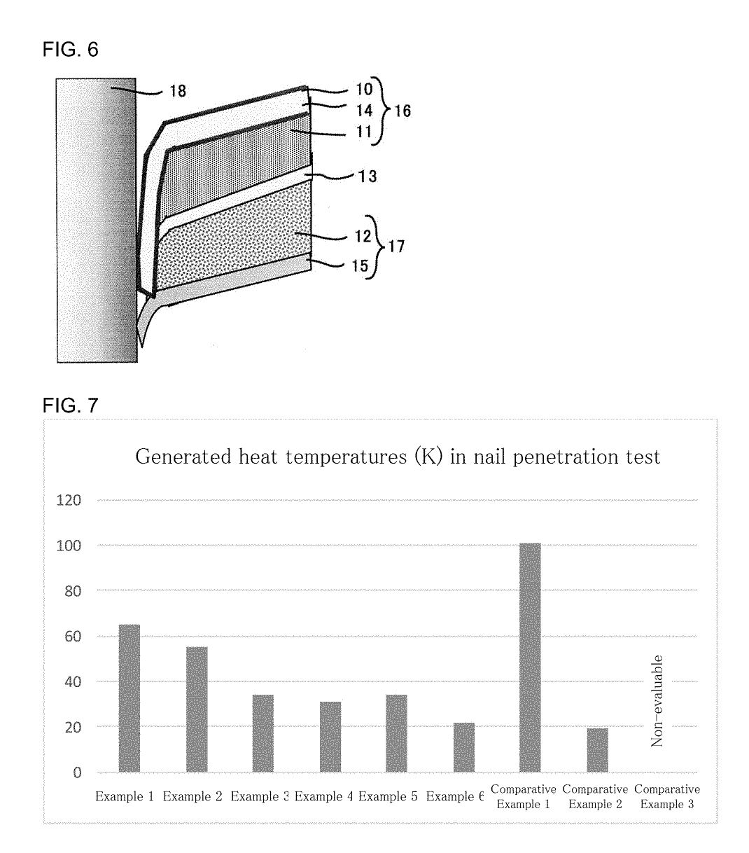

FIG. 6 is a schematic sectional view of an example of an all-solid-state battery at the time of nail penetration. FIG. 6 shows that an all-solid-state battery is penetrated by a nail 18, the battery comprising an electrode 16 (that comprises an electrode active material layer 11 and an aluminum substrate 14 comprising an aluminum oxide layer 10 on the surface thereof), a counter electrode 17 (that comprises a counter electrode layer 12 and a current collector 15), and a solid electrolyte layer 13 (that is disposed between the electrode active material layer 11 and the counter electrode layer 12).

As shown in FIG. 6, at the time of nail penetration, due to the aluminum oxide layer on the surface of the aluminum substrate, the aluminum oxide layer, which is a high-resistance layer, intervenes in a short-circuit path at the time of nail penetration. Therefore, it is considered that an increase in short-circuit resistance occurs and can reduce the amount of generated joule heat.

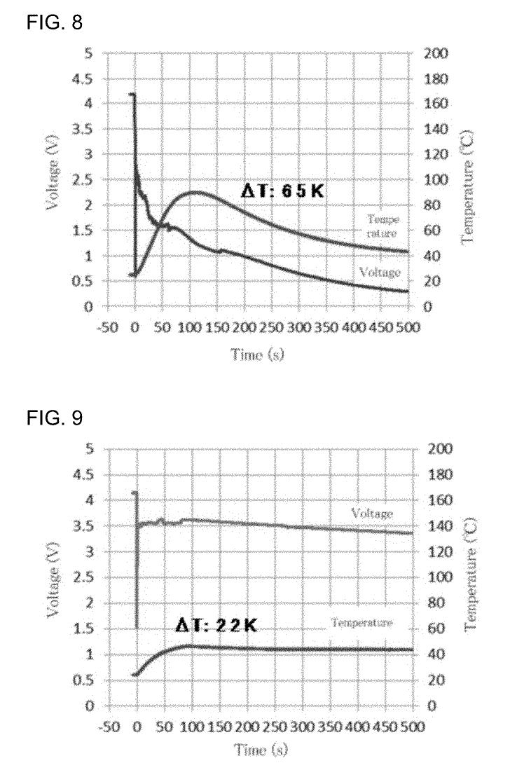

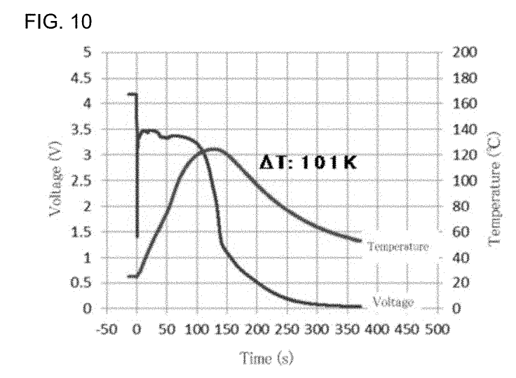

Using the nail penetration tester, the center of the battery was penetrated by a nail (nail diameter: 8 mm) at a nail penetration rate of 25 mm/sec to observe a generated heat temperature. The results are shown in Table 1, FIG. 7, FIG. 8 (the result of observing the generated heat temperature of Example 1), FIG. 9 (the result of observing the generated heat temperature of Example 6) and FIG. 10 (the result of observing the generated heat temperature of Comparative Example 1).

The temperature of a position that is 7 mm higher than the nail penetrated part, was measured. The generated heat temperature ΔT (K) was calculated by the following formula: the measured temperature (° C.)−the battery temperature (° C.) before the test.

As shown in Table 1, the generated heat temperatures are as follows: 65 K in Example 1, 55 K in Example 2, 34 K in Example 3, 31 K in Example 4, 34 K in Example 5, 22 K in Example 6, 101 K in Comparative Example 1, 19.5 K in Comparative Example 2, and non-evaluable in Comparative Example 3 (since the battery could not be charged).

It is clear that for the batteries of Examples 1 to 6 and Comparative Example 2, each of which comprises the aluminum oxide layer, the generated heat temperatures are significantly lower than the battery of Comparative Example 1, which does not comprise the aluminum oxide layer. Therefore, it is clear that as long as the thickness of the aluminum oxide layer is 0.01 μm or more, an excessive increase in battery temperature can be reduced when an abnormality is caused.

From the results of the surface resistance measurement of the aluminum oxide layer and the nail penetration test, it is clear that in the case of Examples 1 to 6, that is, in the case where the surface resistance is 2980 mΩ/cm² or more at a load of MPa, an excessive increase in battery temperature can be reduced when an abnormality is caused by an external shock, etc.

From these results, it is clear that by disposing the very thin aluminum oxide layer having a thickness of from 0.01 to 0.1 μm between the electrode active material layer and the aluminum substrate, a desired power output can be obtained when the battery is in a normal use, without a large decrease in energy density, and the aluminum oxide layer can exercise the battery function suspending effect when an abnormality is caused by an external shock, etc.

1. An all-solid-state battery comprising a cathode, an anode and a solid electrolyte layer disposed between the cathode and the anode,
wherein the cathode and/or the anode comprises:
an aluminum substrate comprising an aluminum oxide layer having a thickness of from 0.01 to 0.1 μm on a surface thereof, and
an electrode active material layer formed on the aluminum oxide layer.

2. The all-solid-state battery according to claim 1, wherein a resistance of the all-solid-state battery is 2980 mΩ/cm² or more at a load of 15 MPa and 150 mΩ/cm² or less at a load of 400 MPa.

3. The all-solid-state battery according to claim 1, wherein the aluminum substrate comprises the aluminum oxide layer on a whole surface thereof.

4. A method for producing the all-solid-state battery defined by claim 1, the method comprising a step of forming the aluminum oxide layer on the aluminum substrate surface by subjecting the aluminum substrate to an alumite or boehmite treatment for 10 to 50 seconds.
